(19) United States
(12) Patent Application Publication
(10) Pub. No.: US 2023/0088128 A1
(43) Pub. Date: Mar. 23, 2023

(54) SYSTEM AND METHOD FOR DETERMINING AN EXPERIENCE MATCH BETWEEN JOB CANDIDATES AND OPEN POSITIONS OR PROJECTS

(71) Applicant: HIREDSCORE INC., New York, NY (US)

(72) Inventors: DIMA SHUGLA, TEL AVIV (IL); OMRI SAPIR, KIBBUZ EIN GEDI (IL); RACHEL ATHENA KARP, NEW YORK, NY (US)

(21) Appl. No.: 17/481,372

(22) Filed: Sep. 22, 2021

(51) Int. Cl. G06Q 10/10; G06Q 10/06; G06N 20/00; G06F 40/205; G06F 40/58

(52) U.S. Cl. CPC G06Q 10/1053; G06Q 10/063112; G06N 20/00; G06F 40/205; G06F 40/58

(57) ABSTRACT

Matching job candidates' experience to open positions by providing a first group of pairs of titles and job descriptions which are similar as first training data into a computerized model, providing a second group of pairs of titles and job descriptions which are not similar as second training data into the computerized model, training the model to output a similarity value of a candidate and an open position based on the first training data and the second training data, and inputting the candidate's data and an open position data into the trained model, where the trained model computes a similarity value indicating a likelihood of a match between the candidate and the open position.

### FIELD

The invention relates generally to computerized processes that improve candidate recruitment.

### BACKGROUND

Hiring the right employees or project workers is one of the biggest challenges for every organization, from multi-national organizations to restaurant chains. Larger organizations naturally recruit more employees and workers, and receive more resumes of candidates for open positions. The resumes may be received via the organizations' websites, email, or via other platforms, mainly digital platforms that send the resumes over the internet, for example to the organizations' Applicant Tracking System or Vendor Management System.

Large corporations employ teams or rely on managers to review the huge number of resumes for each job or project, filtering the job or project candidates and deciding which candidates move to the next recruiting phase, usually phone screens or face-to-face or digital interviews. Due to the large number of resumes, there is a need to use automated tools to perform an initial filtering based on the resumes and applications aligned to the job or project specifications. As the resumes or application profiles are written by the candidates, and the candidates use free language when preparing the resumes, similar experience may be represented in different terms, whereas different experience may be represented in similar terms. This results in low quality analysis of resumes by the automated tools, sometimes filtering out high relevancy candidates, or filtering in low relevancy candidates, resulting in interviewing candidates that do not align to the open position's work experience requirements at a sufficient level or missing out on qualified candidates.

### SUMMARY

The invention, in embodiments thereof, discloses methods for computing a match between a specific open position, or jobs, or projects, or pipelines, and the experience of a candidate. Matching the experience to a job, a series of jobs, projects, or pipelines for future follow-up for a role, which is part of a matching process performed by organizations when receiving a large number of resumes from job or project candidates.

In one embodiment a computerized method is provided for matching job candidates' experience to open positions, the method including providing a first group of pairs of titles and job descriptions which are similar as first training data into a computerized model; providing a second group of pairs of titles and job descriptions which are not similar as second training data into the computerized model; training the model to output a similarity value of a candidate and an open position based on the first training data and the second training data; inputting candidate's data and an open position data into the trained model; the trained model computing a similarity value indicating a likelihood of a match between the candidate and the open position.

In some cases, the method further includes converting the candidate's data representing a specific candidate into a first vector.

In some cases, the method further includes converting the open position data representing an open position into a second vector and executing a function computing the similarity value between the first vector and the second vector.

In some cases, the method further includes converting multiple open position data representing multiple open positions into multiple open vectors, computing multiple similarity values of the candidate to the multiple open positions by comparing the first vector with each of the multiple open vectors, and sorting the multiple similarity values between the candidate and the multiple open positions.

In some cases, the method further includes obtaining a multi-dimensional space including multiple vectors representing multiple open positions, computing a distance between the first vector and the multiple vectors representing the multiple open positions, and selecting specific open positions from the open positions in the space according to distances between the first vector and the multiple vectors representing the multiple open positions.

In some cases, the method further includes obtaining multiple resumes, parsing the multiple resumes, and defining a pair of corresponding title and job description parsed from a resume of the multiple resumes as similar.

In some cases, the method further includes translating a title or job description of the candidate's data from one language to another language.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a method of matching experience between candidates and open positions, according to exemplary embodiment of the invention.

FIG. 2 shows a method of generating training data when matching candidates' experience to positions, according to exemplary embodiment of the invention.

FIG. 3 shows a method of using the trained model for matching candidates' experience to positions, according to exemplary embodiment of the invention.

FIG. 4 schematically shows a method of computing a match between candidates' experience to positions, according to exemplary embodiment of the invention;

FIG. 5 schematically shows a process and a system for matching a candidate's experience to an open position, according to exemplary embodiment of the invention.

### DETAILED DESCRIPTION

The technical challenge solved using the subject matter described herein is to achieve high quality matching between job or project descriptions and an experience of a job candidate. A fundamental component of the high quality matching is the ability to determine whether a single job position, for example provided from a candidate's resume, has experience which is relevant to a job or project description. In a more general definition, given two descriptions of jobs, determine if they are similar or “close” (is one relevant to the other).

The computerized solution to achieve the high quality matching utilizes a large number of candidates resumes, for example millions of resumes, and extracts deep representations of positions descriptions from the candidates' resumes. Then, the method of the subject matter uses these representations to compute a similarity value in a high dimensional space to determine the match. The method works when determining a match in a single language, and also when determining a match among candidates' resumes and job or project descriptions written in different languages (cross-language matching).

The method of the subject matter includes obtaining the candidates' data, for example resumes, and jobs' and projects' descriptions. Then, the method includes extracting text from the candidates' data and generating training data from the jobs and projects and candidates' resumes to output pairs of texts which are tagged as similar or non-similar. The method then includes training a computerized model using the pairs of texts which are tagged as similar or non-similar and using the model to determine a similarity value between a job or project and a candidate.

The term “job candidate” refers to a person sending a message or a request informing an organization that the person wishes to be employed in a specific job or project, or in multiple relevant jobs in the organization.

The term “training”—refers to a process in which a machine learning algorithm is created using an input training set with examples. The output is a model that can predict the match of a candidate to a job or project when both are given as new inputs to the model. In some cases, the aim of the model training is to create representations of “jobs” or “open positions” or “open projects” in an organization in a multi-dimensional space in such a way that jobs of the same professions will be placed in the same “area” in the multi-dimensional space. Placing similar jobs in the same area enables to “match” jobs using a distance metric function, for example Euclidian or cosine function. The training may be done using many methods including language models.

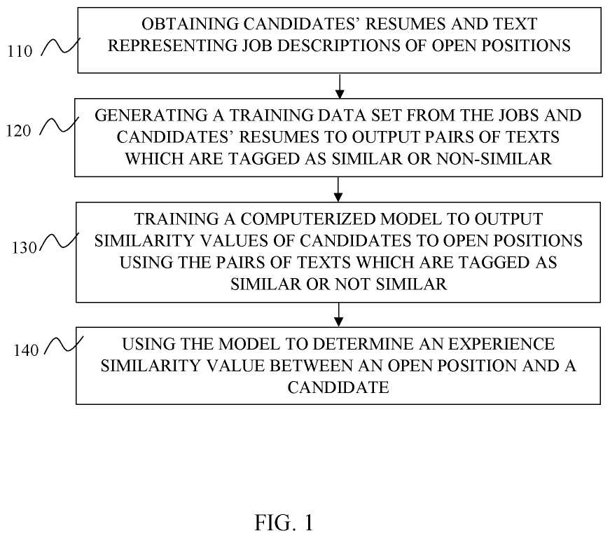

FIG. 1 shows a method of matching between candidates' experience and open positions, according to exemplary embodiment of the invention.

Step 110 discloses obtaining candidates' data and text representing job descriptions of open positions. The candidates' data can be provided from Application Tracking System (Client), Vendor Management System (Client), CRM systems, employees data, from dedicated websites 3rd party candidate pools and the like. The candidates' data may include structured resumes or profiles or unformatted information inputted into a document or into a form or fields or even images of resumes or a person's past project or any other way to understand candidate abilities. The candidates' data may include data fields filled by the candidate or by another person or computerized entity. The data fields may be provided in addition to the resume, or instead of the resumes. For example, a data source with job or project requirements/descriptions and candidate abilities/resumes and a positive/negative decision on the candidate match to the requirements (or a multi-level or continuous grade given by humans to this match).

Step 120 discloses identifying generating a training data set from the jobs and candidates' resumes to output pairs of texts which are tagged as similar or non-similar. The training data set is configured to train a computerized model, for example a model receiving data to compute a match between a candidate and a job opening. The pair of texts represent one job title and one job description. This way, the model receives a large number of pairs, each pair is tagged as similar or not similar, and the model can use this training data set to train and later determine similarity between a candidate and an open position. In some cases, the pairs are tagged in additional tags or values, for example a numeric value indicating a level of similarity, for example “1” representing a lowest similarity and “10” representing a highest similarity.

Step 130 discloses training a computerized model to output similarity values of candidates to open positions using the pairs of texts which are tagged with a similarity value. The similarity value may be similar or non-similar, or another alphanumeric value. The training outputs a software algorithm that predicts the likelihood that a candidate matches a job position based on the candidate's resume and job description.

The model may use the representation vectors output from a language model such as Bidirectional Encoder Representations from Transformers (BERT). The model may then be adjusted by defining the model's objective to maximize a similarity value between pairs of text tagged as similar and minimize a similarity value between pairs of text tagged as non-similar pairs. Training the model may also include using the final pooling layer of the model as the representation of the text. Many language models create deep representation for words. The deep representations may be required for sentences or even longer texts (the position titles and position descriptions). Pooling is a process or logic in which representations of the words and creates a value representing the text, for example the sum of all words, a mean of all words and the like.

Step 140 discloses using the model to determine an experience similarity value between an open position and a candidate. The open position and the candidate are not part of the training data set. The similarity value may be defined in a range set by a software or by a person.

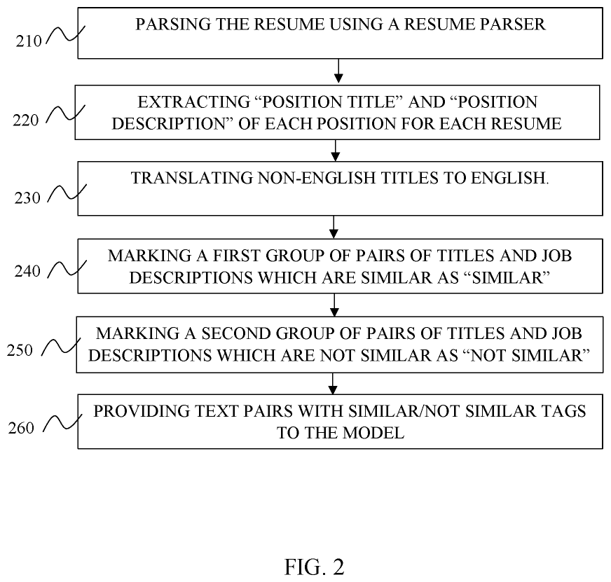

FIG. 2 shows a method of generating training data when matching candidates' experience to positions, according to exemplary embodiment of the invention.

Step 210 discloses extracting data from candidates' resume. The data may be extracted using parsing, or using another process desired by a person skilled in the art. The data may be job-related characteristics, such as experience, education, skills, volunteering experience and the like. The data may be text inputted in one or more languages.

Step 220 discloses Extracting “position title” and “position description” of each position for each resume. In many resumes, a candidate's employment experience is written in sections, each section is allocated to a job that the candidates had. The job may include a name of the organization in which the candidate filled the job, the job's title, and job's description. The text used to describe the job's title, and job's description is likely to be selected by the candidate. The software performing the process of generating the training data set may identify the title from the resume's text according to the location in the resume. Identifying the title may be performed by comparing the text to a list of optional titles and recognizing the text from the resume in the list.

Step 230 discloses translating titles from one language to another language. For example, titles may be translated from a non-English language to English. The translation may be performed by a person inputting the translated text into an input unit such as a user interface, or a machine-based translation, such as Google translating engine, a translator operating locally or online, and any other digital translator desired by a person skilled in the art.

Step 240 discloses marking a first group of pairs of titles and job descriptions which are similar as “similar”. The pairs of titles and job descriptions may be extracted from resumes received at the organization, or from external resources, such as an online database of resumes, profiles on business-focused social networks such as LinkedIn, and the like. Regular positions in a resume contains details about the company the candidate worked for, the position title, the start date and the end date of the position and the position description which is usually a free text the candidate writes about what she/he did in this position. The resumes, or other resources elaborated above, provide a sufficient indication that the job description is relevant to the title. Hence, the pair is tagged as “similar”, meaning that the title is sufficiently represents the job description.

For example, the title “software engineer” will be tagged as similar to many job descriptions having different texts, as extracted from various resumes. For example, one job description is “design an automated web content extractor system to search filtering download and storage news for further analytics”. Another job description sufficiently represented by the title “software engineer” is as follows: “built a web based insurance application that helps the consumer to get policy quotes and manage policies”.

Step 250 discloses marking a second group of pairs of titles and job descriptions which are not similar as “not similar”. The pairs of not similar texts may be provided based on data extracted from multiple resumes. For example, extracting a job description from a resume of one person and a job description from a resume of another person. In some cases, the not similar pairs can be selected or inputted by a person, for example a recruiter in an organization.

Step 260 discloses outputting text pairs with similar/not similar tags to the model. Outputting may be performed automatically, for example using a computer software, which inputs the tagged pairs of text into memory addresses of a device, or into a software application dedicated for receiving pairs of text. Outputting may be provided manually, for example by a person typing the text into an input unit, such as a user interface or a server.

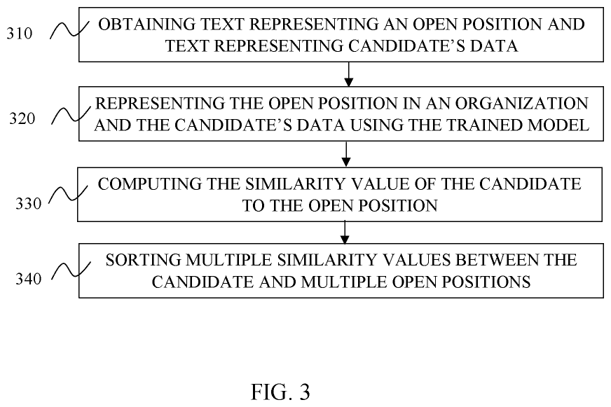

FIG. 3 shows a method of using the trained model for matching candidates' experience to positions, according to exemplary embodiment of the invention.

Step 310 discloses obtaining text representing an open position and text representing candidate's data. At least one of the open position and the candidate's data were not included in the training data. The text representing candidate's data may be extracted from a resume, for example by parsing the resume. The text representing the open position may be uploaded into a web-based server by recruiting personnel of an organization. The resume may be uploaded by a candidate, a candidate's representative, or recruiting personnel wishing to receive a similarity level of the candidate to open positions in the organization.

Step 320 discloses representing the open position in an organization and the candidate's data using the trained model. The trained model is configured to compute a vector representing the candidate based on the text in the candidate's resume. The vector includes multiple dimensions, including, for example, titles in the candidate's resume, job descriptions in the candidate's resume, title of the open position, job description in the open position and additional information inputted by a recruiter of the organization, such as urgency level to fill the position. Properties of the vector may be determined by a person skilled in the art. The trained model may also be configured to compute a vector representing the job description. The vectors fit a domain of multiple dimensions in which the vectors can be stored. The vectors may be digitally represented in a memory address of an electronic device, such as a server, a personal computer, a laptop and the like.

Step 330 discloses computing the similarity value of the candidate to the open position. The similarity value may be computed by a computing device configured to output a similarity value or a similarity score of the candidate's data and the open position data. The computing device may be a component in the trained model, or may be part of another machine or device. The similarity value may be an output of a function that receives the vectors representing the candidate's data and the open position. The function may be cosine distance function, a Euclidian distance function, or any other similarity function desired by a person skilled in the art.

Step 340 discloses sorting multiple similarity values between the candidate and multiple open positions. In such case, the vector representing the candidate's data is compared with multiple vectors representing open positions. The comparisons with the multiple vectors result in multiple similarity values. The computing device performing the comparisons may sort the similarity values to indicate which open positions are more relevant to the candidate.

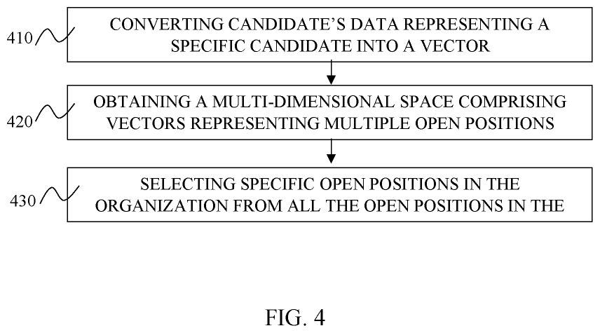

FIG. 4 schematically shows a method of selecting open positions which are relevant to a specific candidate, according to exemplary embodiment of the invention.

Step 410 discloses converting candidate's data representing a specific candidate into a vector. The vector is created by the trained model based on the large number of pairs of similar and not similar titles and job descriptions.

Step 420 discloses obtaining a multi-dimensional space including vectors representing multiple open positions. Each open position in the multi-dimensional space is represented by a vector generated by the trained model. The vectors may have the same number of dimensions, and generated according to the same set of rules.

Step 430 discloses selecting specific open positions from all the open positions in the space. The specific open positions have a higher likelihood to match with the candidate. For example, the computing device may select open positions having a similarity value higher than a predefined threshold. In some other cases, the computing device may select the best five (5) open positions, indicating the similarity value of each open position relative to the candidate.

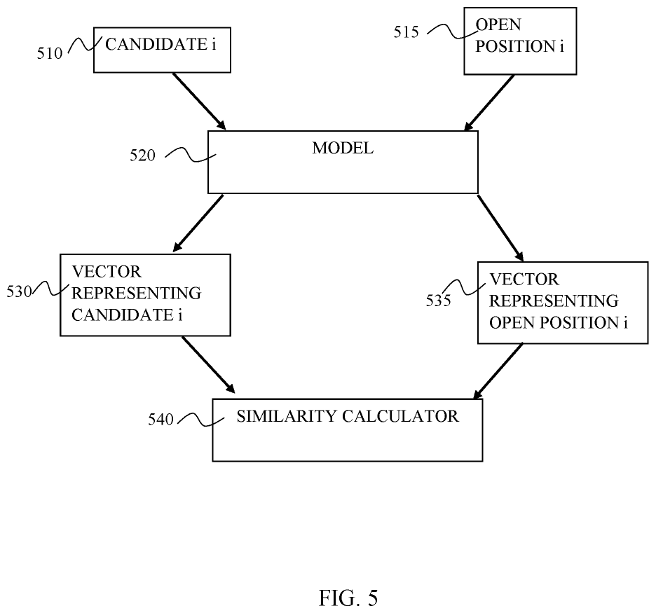

FIG. 5 schematically shows a process and a system for matching a candidate's experience to an open position, according to exemplary embodiment of the invention. At first, text representing the candidate 510 and text representing the open position 515 are inputted into the trained model 520. The output from the trained model 520 includes a vector representing the candidate 530 and a vector representing the open position 535. Then, both vectors 530 and 535 are inputted into a computing device 540 that executes a function or algorithm for computing a similarity value between the vectors 530, 535. The computing device 540 may be part of the model 520, or be located in another machine or device.

The processes described above are performed by a computerized system or device, for example a server, a laptop, a tablet computer, a personal computer. The computerized system or device includes a processor that manages the processes. The processor may include one or more processors, microprocessors, and any other processing device. The processor is coupled to the memory of the computerized system or device for executing a set of instructions stored in the memory.

The computerized system or device includes a memory for storing information. The memory may store a set of instructions for performing the methods disclosed herein. The memory may also store the candidates' data, the training set, the test set, rules for building the software model and the like. The memory may also store rules for moving the radar, for example moving along the rail or moving using an arm, based on an event, or based on data extracted from the radar's measurements. The memory may store data inputted by a user of the computerized system or device, such as commands, preferences, information to be sent to other devices, and the like. The computerized system or device may also include a communication unit for exchanging information with other systems/devices, such as servers from which the candidates' data is extracted.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiments disclosed herein for carrying out this invention.

1. A computerized method for matching job candidates' experience to open positions, the method comprising:
providing a first group of pairs of titles and job descriptions which are tagged as similar as a first training data into a computerized model;
providing a second group of pairs of titles and job descriptions which are tagged as not similar as a second training data into the computerized model;
training the model to output a similarity value of a candidate and an open position based on the first training data and the second training data, wherein the training outputs a software algorithm that predicts the likelihood that a candidate matches a job position based on the candidate's resume and job description;
inputting candidate's data and an open position data into the trained model;
the trained model computing a similarity value indicating a likelihood of a match between the candidate and the open position.

2. The method of claim 1, further comprising converting the text in the candidate's data representing a specific candidate into a first vector.

3. The method of claim 2, further comprising:
converting the open position data representing an open position into a second vector;
executing a function computing the similarity value between the first vector and the second vector.

4. The method of claim 2, further comprising:
converting multiple open position data representing multiple open positions into multiple open vectors;
computing multiple similarity values of the candidate to the multiple open positions by comparing the first vector with each of the multiple open vectors;
sorting the multiple similarity values between the candidate and the multiple open positions.

5. The method of claim 2, further comprising:
obtaining a multi-dimensional space comprising multiple vectors representing multiple open positions;
computing a distance between the first vector and the multiple vectors representing the multiple open positions;
selecting specific open positions from the open positions in the space according to distances between the first vector and the multiple vectors representing the multiple open positions.

6. The method of claim 1, further comprising:
obtaining multiple resumes;
parsing the multiple resumes;
defining a pair of corresponding title and job description parsed from a resume of the multiple resumes as similar.

7. The method of claim 1, further comprising translating a title or job description of the candidate's data from one language to another language.
